(19) United States
(12) Patent Application Publication
(10) Pub. No.: US 2019/0256292 A1
(43) Pub. Date: Aug. 22, 2019

(54) MATERIAL HANDLING SYSTEM WITH INTEGRATED SERVICE PLATFORM

(71) Applicant: Opex Corporation, Moorestown, NJ (US)

(72) Inventors: Erick Grasmueck, Voorhees, NJ (US); Jeffery Kolarovic, Delanco, NJ (US)

(21) Appl. No.: 16/246,905

(22) Filed: Jan. 14, 2019

Related U.S. Application Data
(60) Provisional application No. 62/617,124, filed on Jan. 12, 2018.

(51) Int. Cl. B65G 1/137

(52) U.S. Cl. CPC B65G 1/1378; B65G 2203/0283

(57) ABSTRACT

A method and apparatus are provided for delivering items to a plurality of storage locations is provided. The system includes a plurality of storage locations. The storage locations may be positioned to provide an aisle and a delivery mechanism may be operable within the aisle to deliver items to the storage locations. A service platform may be provided. The service platform may be displaceable within the aisle to provide an elevated platform for an operator to provide service to the delivery mechanism or the storage locations.

### Priority Claim

This application claims priority to U.S. Provisional Patent Application No. 62/617,124 filed on Jan. 12, 2018. The entire disclosure of the foregoing application is incorporated herein by reference.

### Field of the Invention

The present invention relates to material handling systems and, more particularly, to systems that utilize a plurality of storage locations in one or more storage racks. More particularly, the present invention relates to such material handling systems that utilize a plurality of automated vehicles for delivering items to the storage locations.

### BACKGROUND OF THE INVENTION

The use of automated storage and retrieval has significantly improved the efficiency of material handling. For instance, in the order fulfillment application, automated storage and retrieval systems have significantly reduced the time required to retrieve the items required to fulfill a customer order. A variety of automated storage and retrieval systems are currently known. One exemplary type of system utilizes one or more storage racks, a plurality of vehicles and a track for guiding the vehicles to the storage locations on the racks. However, difficulties may arise with the vehicles or at a storage location, thereby requiring human intervention to rectify the problem. Unfortunately, access to the vehicle or sorting location can be difficult and can risk damage to the operator and/or the system. Accordingly, there is a need in automated system to provide ready access to the storage locations and vehicles to provide service when necessary.

### SUMMARY OF THE INVENTION

According to one aspect, the present invention provides a material handling apparatus that includes a displaceable platform for servicing the apparatus. In particular, the apparatus may include a plurality of storage locations for receiving items. The storage locations may be positioned so that an aisle is formed between the storage locations. A delivery mechanism may be displaceable within the aisle to deliver items to the storage locations. The displaceable platform may be displaceable within the same aisle as the delivery mechanism.

According to a further aspect, the delivery mechanism is a delivery vehicle having wheels and the apparatus includes a guide within the aisle for guiding the delivery vehicle in the aisle, wherein the displaceable platform is configured to engage the guide to guide the platform along the guide.

According to a further aspect, the displaceable platform comprises a roller assembly and the guide is a track, wherein the roller assembly is configured to roll in the track.

According to a further aspect, the displaceable platform comprises a plurality of feet for supporting the platform, wherein the roller assembly is displaceable between a first position and a second position, wherein in the first position the feet are elevated so that the feet do not support the platform and a second position wherein the feet support the weight of the platform.

According to a further aspect, the present invention provides a displaceable service platform cooperable with a material handling having a plurality of storage locations and an aisle formed between the storage locations and a track for guiding a delivery mechanism in the aisle to deliver items to the storage locations. The service platform includes an elevated platform configured to support an operator so that the operator can operate within the aisle. The platform further includes a roller assembly connected with the elevated platform, wherein the roller assembly is operable to roll the platform within the aisle and wherein the roller assembly is configured to cooperate with the track that guides the delivery mechanism. A plurality of feet support the elevated platform to prevent the platform from moving in the aisle. The roller assembly is displaceable relative to the feet between a first position and a second position, wherein in the first position the feet are elevated and do not support the elevated platform and in the second position the feet support the platform to thereby impede displacement of the platform within the aisle.

According to a further aspect, the service platform includes a biasing element biasing the roller assembly toward the first position.

According to yet another aspect, the service platform includes a plurality of generally horizontal platforms vertically spaced apart from one another, each forming a support surface for supporting the weight of the operator.

While the methods and apparatus are described herein by way of example for several embodiments and illustrative drawings, those skilled in the art will recognize that the inventive methods and apparatus for sorting items using a dynamically reconfigurable sorting array are not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the methods and apparatus for sorting items using one or more dynamically reconfigurable sorting array defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### BRIEF DESCRIPTION OF THE DRAWINGS

The foregoing summary and the following detailed description of the preferred embodiments of the present invention will be best understood when read in conjunction with the appended drawings, in which the same reference numbers will be used throughout the drawings to refer to the same or like parts:

FIG. 1 is a perspective view of a material handling apparatus incorporating aspects of the present invention.

FIG. 2 is a plan view of the material handling system illustrated in FIG. 1.

FIG. 3 is an enlarged fragmentary view of a lefthand portion of the material handling apparatus illustrated in FIG. 1 shown from the rear side of the apparatus with an enclosure.

FIG. 4 is an enlarged fragmentary view of a righthand portion of the material handling apparatus illustrated in FIG. 1 shown from front side of the apparatus with an enclosure.

FIG. 5 is a fragmentary side view of the portion of the apparatus illustrated in FIG. 4.

FIG. 6 is a perspective view of a displaceable service platform operable in connection with the material handling apparatus illustrated in FIG. 1.

FIG. 7 is a side view of the displaceable service platform illustrated in FIG. 5.

FIG. 8 is a plan view of a lefthand portion of the apparatus illustrating a storage area.

### DETAILED DESCRIPTION OF THE INVENTION

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

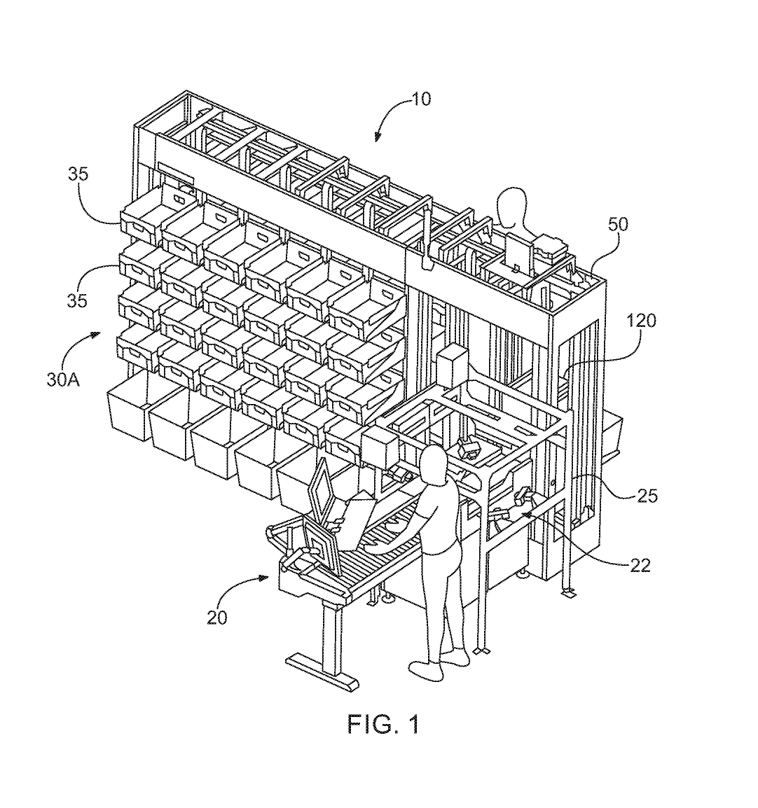

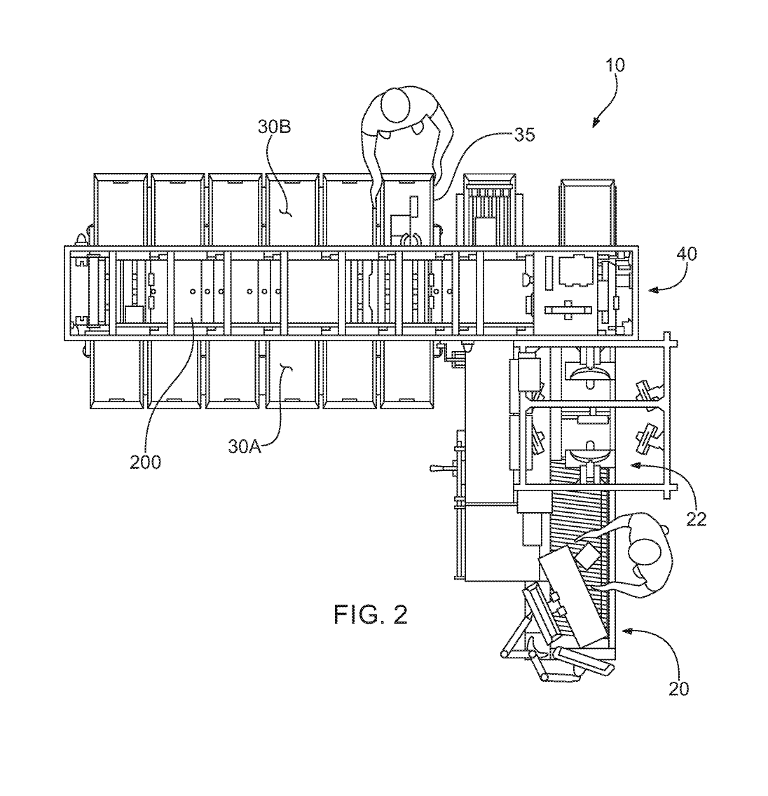

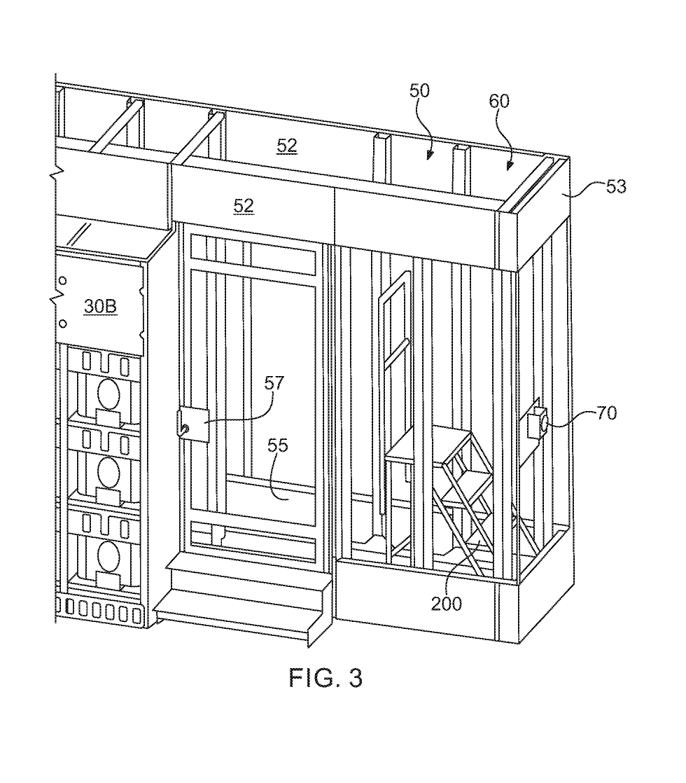

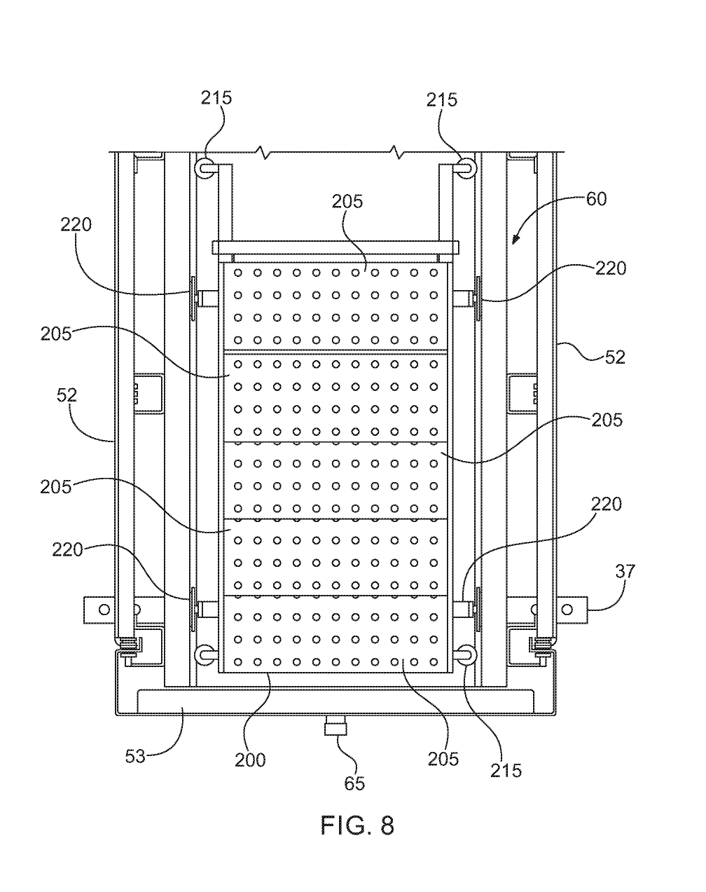

Referring now to FIGS. 1-5 generally and to FIGS. 1-2 specifically, a material handling apparatus is designated 10. The system 10 may take any number of forms that incorporate a plurality of storage locations. In the present instance, the system includes a pair of spaced apart storage racks 30A, 30B with an aisle 40 formed between the storage racks. A plurality of automated delivery vehicles 120 may operate within the aisle 40. In particular, the delivery vehicles 120 may travel along a track 100 that is positioned in the aisle, as described further below. Additionally, as shown in FIGS. 3-8 and described in greater detail below, the system 10 may include one or more mechanisms to improve the safety of the system and to facilitate safe and efficient access to the storage locations from within the aisle to provide service or maintenance to the system.

As noted above, the material handling apparatus may take any of a number of forms that include a number of storage locations. Preferably, the material handling apparatus 10 includes a number of automated vehicles. However, it should be understood that aspects of the present invention are applicable to systems that do not include automated vehicles.

In the exemplary system illustrated in FIGS. 1-2, the material handling apparatus includes a station for feeding items into the system. This station is referred to as the induction station 20. The induction station 20 determines an identifying characteristic for the items to be fed into the system. The identifying characteristic can be any of a variety of characteristics, such as a product number or UPC code. The identifying characteristic can be determined manually, such as by an operator. However, in the present instance, the induction station includes a scanning station 22 that may include a plurality of scanners, such as optical scanners in the form of a bar code scanner, digital camera or otherwise. The induction station may include a conveyor for conveying the items past the scanner or the operator may manually scan the items before they are fed into the system.

The induction station 20 preferably includes a conveyor for serially conveying items to a loading station 25 where the items are loaded onto vehicles 120. A plurality of items may be loaded onto each vehicle. However, in the present instance, each item is loaded onto a separate vehicle and the vehicle then delivers the item to one of the storage locations.

Although the configuration of the induction station may vary, details of an exemplary induction station are provided in U.S. application Ser. No. 15/586,247. The entire description of U.S. application Ser. No. 15/586,247 are hereby incorporated herein by reference. Additionally, it should be noted that the induction station is not a necessary element and that aspects of the invention can be utilized in a system that does not include an induction station.

Referring again to FIGS. 1-2 the details of the storage assembly will be described in greater detail. The system includes a plurality of storage locations 32 for storing items so that the items may be retrieved. In one configuration, the items are delivered to the storage locations by a plurality of automated vehicles 120. Additionally, the system may be configured so that the items can be retrieved from the storage locations by the automated vehicles. Alternatively, the storage locations may be used to accumulate items so that an operator or other automated retrieval device can retrieve the items from the storage location. For instance, a storage bin 35 may be located in each storage location 32 and the system may deliver items to the different storage bins to fulfill customer orders. Once the system has delivered all of the items to a particular storage bin, an operator removes the storage bin 35 from the storage location 32 and replaces the full storage bin with an empty storage bin.

The storage locations may be arranged in any of a variety of orientations. For instance, referring to FIGS. 1-2, the system includes two opposing racks, a front rack 30A and a rear rack 30B. The racks 30A, 30B are spaced apart from one another, forming an aisle 40 between the racks. Optionally, the racks 30A, 30B may be connected by a plurality of cross brackets 37 that interconnect the racks. In particular, a plurality of top cross brackets 37 may extend between the tops of the racks and a plurality of cross braces 37 may extend between the bottoms of the racks thereby connecting the racks and maintain the racks spaced apart to provide the aisle 40. A plurality of generally planar flooring sections may span between the racks over top of the cross brackets to provide a generally planar floor in the aisle.

The storage locations 32 are located on the racks 30A, 30B. The storage locations may be configured in a variety of configurations, such as in a plurality of rows or columns. In the embodiment illustrated in FIGS. 1-5 the storage locations are arranged in a plurality of columns.

As described further below, one or more delivery mechanisms operate within the aisle 40 to deliver items to deliver items to the storage locations in both the front rack 30A and the rear rack 30B. To prevent operator interference and to reduce injury to operators and/or the system, the storage racks include one or more enclosures to impede entry into the aisle 40.

Referring to FIG. 3 an enclosure for an end of the aisle 40 is designated generally 50. The enclosure 50 is configured to close the end of the aisle to impede entrance into the aisle during operation. The enclosure comprises one or more walls that span across the aisle 40 to prevent entrance into the aisle. The enclosure extends up at least a significant portion of the height of the aisle. For instance, the enclosure may extend upwardly at least 36″ to impede entrance into the aisle. In the present instance, the enclosure 50 extends at least halfway up the height of the aisle. Additionally, as shown in FIG. 3, the enclosure extends substantially the entire height of the aisle.

Additionally, the enclosure 50 is also configured to allow access to the aisle so that an operator can attend to service or maintenance required. For instance, if a delivery mechanism jams or fails the operator may need to access the aisle to retrieve the delivery mechanism. Similarly, if an item becomes lodged in a storage location or somewhere in the aisle, the operator may need to access the aisle 40 retrieve the jammed item. Accordingly, the enclosure 50 preferably includes an access door 55. The enclosure may be configured so that the access door 55 is parallel to the end wall of the storage racks 30A, 30B. In such a configuration, the door may form the wall that closes the end of the aisle.

Alternatively, as shown in FIG. 3 it may be desirable to extend the enclosure away from the ends of the rack to form an enlarged enclosure so that the door may be formed on a wall parallel to the side of the racks 30A, 30B as opposed to parallel to the end of the racks. In such an embodiment, the enclosure 50 elongates the aisle 40 past the end of the storage racks 30A, 30B. By extended the enclosure along the length of the aisle, the sides of the enclosure 50 can be longer than the width of the aisle. Additionally, a door can be built into a side of the enclosure and since the side is longer than the width of the aisle, the access door 55 may be configured to have a width that is greater than the width of the aisle. In other words, the width of the access door 55 is greater than the distance between the opposing racks 30A, 30B.

The extended enclosure illustrated in FIG. 3 includes a pair of substantially parallel side walls 52 that extend parallel to the aisle 40. An end wall 53 extends between the side wall to close the opening between the side walls. The length of the sidewalls may vary depending upon the application. For instance, the side walls may extend just past the access door to form a vestibule at the end of the aisle that is about as long as the width of the access door. Alternatively, as shown in FIG. 3, the side wall 52 may extend substantially past the access door 55 to provide a storage area 60 for storing service equipment or other elements, such as extra delivery vehicles. As discussed further below, the storage area 60 is configured to accommodate a service platform 200 to be used to support an operator while the operator is working in the aisle.

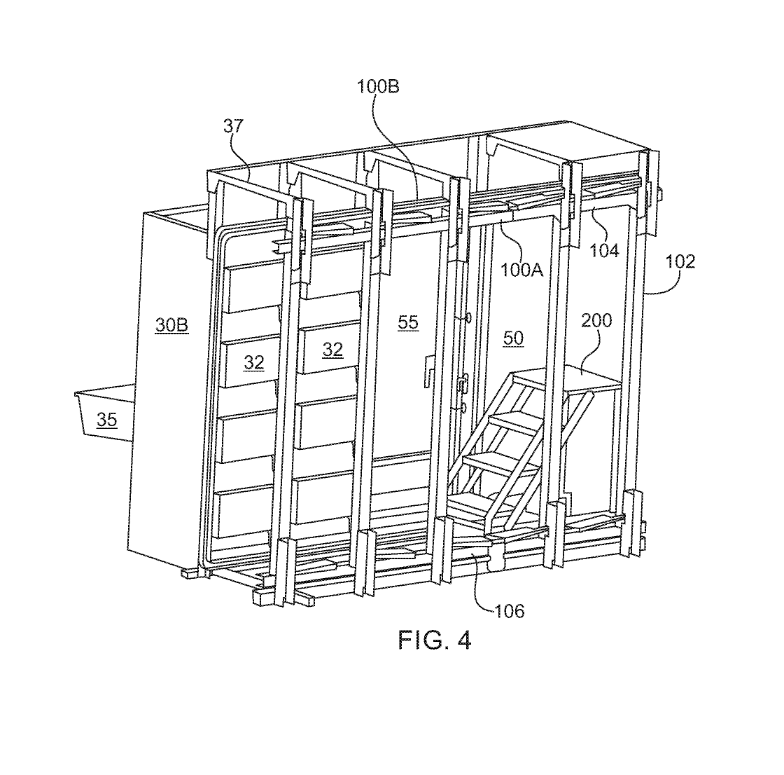

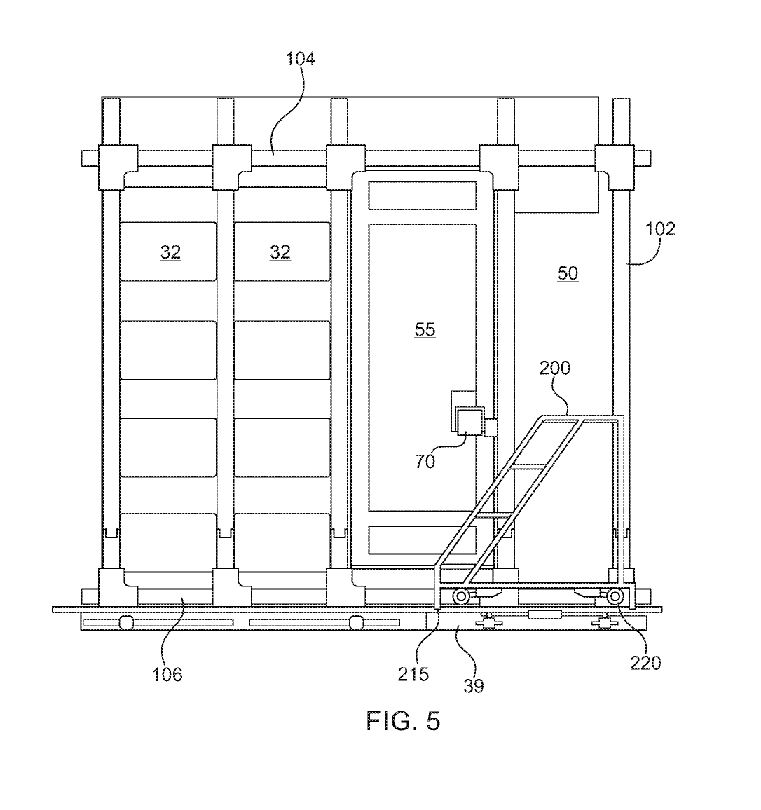

The length pf the storage racks 30A, 30B may vary depending on the application. For example, in some applications the storage racks may extend 80 feet so that the aisle is 80 feet long. To improve egress from within the aisle, the system may include an enclosure at both ends of the aisle and an access door may be formed in each enclosure so that the aisle may be accessed from either end. Referring to FIGS. 4-5 the enclosure 50 at the right end of the storage racks is illustrated with the front rack 30A removed to show the details within the aisle 40. The access door 55 is built into the rear wall 52 of the enclosure at the right end. Similarly, in FIG. 3 the enclosure 50 enclosing the left end of the aisle 40 is illustrated. The access door 55 is formed in the back wall of the enclosure. Alternatively, the access door may be formed in the front side wall of the enclosure. In this way, the system may include enclosures extending the aisle at both ends of the storage racks 30A, 30B. Additionally, the enclosures may be configured to provide an access door 55 in each enclosure to provide an access door at each end of the aisle.

As described above, the enclosure 50 is configured to close of the end of the aisle to prevent personnel from entering the aisle while the delivery mechanism(s) is/are operating in the aisle. However, as noted above, the enclosure preferably includes an access door to allow the operator to have access to the aisle. Accordingly, an interlock switch 57 may be positioned relative to the door to detect whether the door is open. The interlock switch provides a signal to the central controller that controls operation of the system. In particular, the central controller controls operation of the delivery mechanisms in the aisle 40. If the central controller receives a signal from the interlock switch 57 indicative of the access door being open, the central controller immediately provides signals to the delivery mechanisms and other elements of the system to halt operation of the system. In this way, the interlock switch 57 ensures that the delivery mechanisms do not operate within the aisle while the access door is open.

The access door may also include an element to ensure that the access door does not accidentally close while the operator is in the aisle. In particular, the access door includes a blocking element that automatically blocks the door in the open position when the door is opened. In order to close the door, the latching mechanism must be manipulated by the operator to remove the blocking element. In this way, the door cannot be accidentally closed.

Additionally, since the operator may not be visible when working in the aisle, if someone closes the access door 55 while an operator is in the aisle, it may be possible to re-start operation of the system. Accordingly, the system may include one or more emergency switches to automatically shut off the system. For instance, referring to FIG. 5 an emergency switch 65 may be positioned inside the enclosure 50. The emergency switch 65 may automatically open the access door 55, thereby actuating the interlock switch 57 to shut down operation of the system. Additionally, the system may include one or more emergency stop switches 70 located on the outside of the enclosure 50 so that an operator outside of the aisle can automatically shut own operation of the system by actuating the emergency stop switch 70.

As described above, the system may include one or more delivery mechanisms that operate within the aisle 40 to deliver items to the storage locations 32. One such exemplary delivery mechanism is an automated delivery vehicle 120 configured to move along a track 100 within the aisle to deliver items to the storage locations 32. The details of exemplary embodiments of delivery vehicles and a track system are described in detail in U.S. application Ser. No. 15/586,247, the entire disclosure of which is hereby incorporated herein by reference.

The delivery vehicles 120 include a platform onto which an item may be placed. The platform 122 may be a stationary platform and the system may include elements onto the platform and unload items from the platform. Alternatively, the platform may be moveable. For instance, the platform may be one or more horizontal belts. The belts may be selectively operable to convey an item onto the vehicle. Similarly, the belts may be selectively operable to discharge items from the belt. The delivery vehicle may also include a plurality of drive wheels 125 that drive the vehicle along the track 100. In the present instance, the delivery vehicles include two pairs of wheels mounted on two spaced apart axles. In this way, the vehicle includes two front wheels that engage a front track 100A adjacent the front rack 30A and two rear wheels engage a rear track 100B adjacent the rear rack 30B.

The track 100 may include a variety of configurations. In the present instance, the track includes front and rear tracks 100A, 100B positioned on opposing sides of the aisle 40. The vehicles 120 operate in the aisle between the racks 30A, 30B. In this way, the delivery vehicles span the width of the aisle so that the vehicles can deliver items to storage locations in the front rack 30A or to storage locations in the rear rack 30B. The rear track 100B is configured substantially similarly to the front track 100A so that the two tracks form opposing tracks that cooperate with the delivery vehicles to guide the delivery vehicles. Accordingly, in the following discussion, it should be understood that the described details of the track apply to both the front track 100A and the rear track 100B.

In particular, in the present instance, the storage racks 30A, 30B are configured so that the storage locations are arranged in a plurality of columns. Accordingly, the track 100 comprises an upper rail 104 and a lower rail that are interconnected by a plurality of vertical tracks 102. During operation, a vehicle departs the loading station 25 with an item and travel up a vertical track to the upper frail 104. The vehicle 120 travels along the upper rail 104 until reaching the appropriate column. The vehicle then travels down the column to the appropriate storage location 132. The vehicle then travel down to the column to the lower rail 106. The vehicle travels along the lower rail to return to the loading station to receive another item. In this way the vehicles loop around the track 100 to deliver items to storage locations. As the vehicles travel along the track, the vehicles move through the aisle 40.

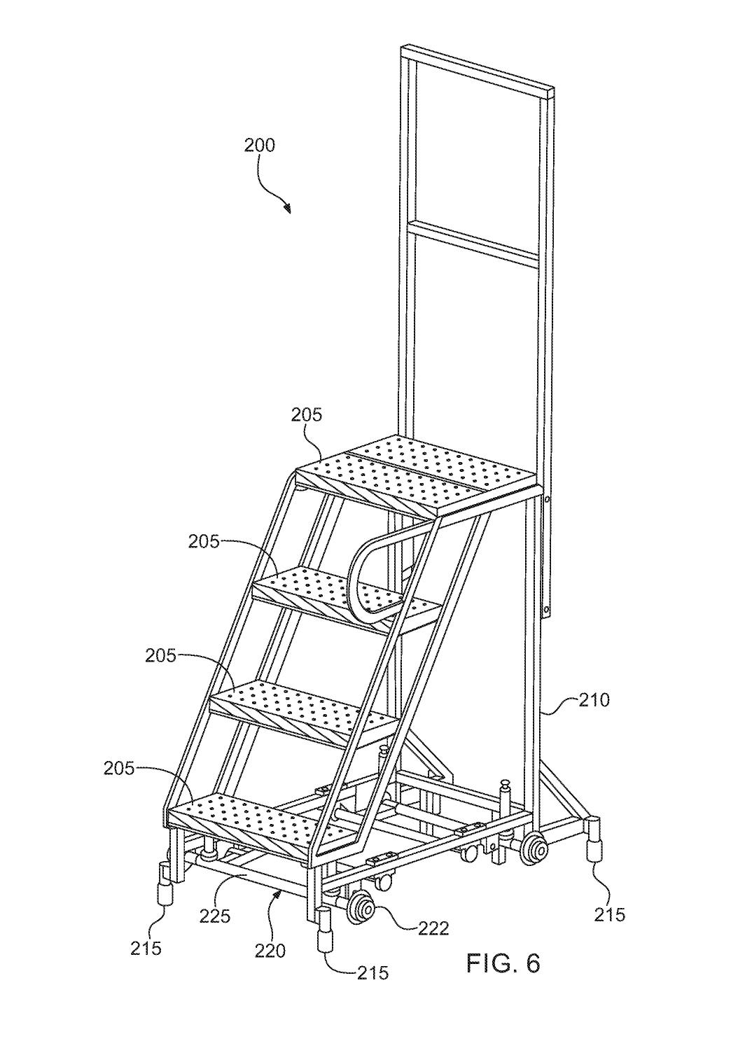

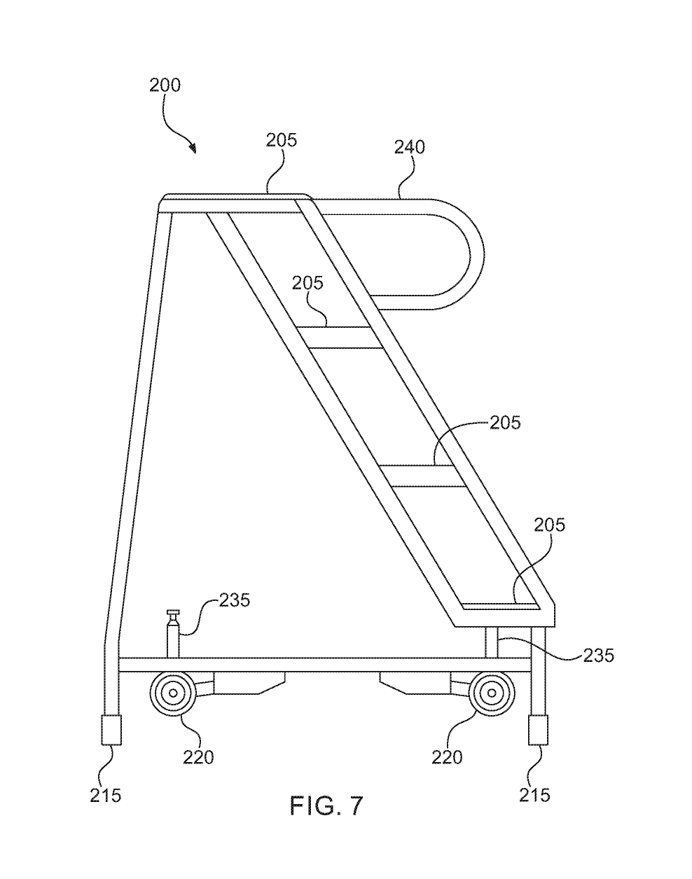

Referring now to FIGS. 6-7, the system may include a service platform assembly 200 that may be configured to cooperate with the track system that also guides the vehicles. In particular, the service platform 200 may include a roller assembly 220 that rides in the lower rail 106 to move the service platform through the aisle as described further below.

The service platform 200 comprises one or more elevated platforms that provide a working platform to support an operator during maintenance of the system. In this way, the service platform assembly 200 provides an elevated surface so that an operator can reach up to retrieve a delivery mechanism or other element in the storage rack that may require service or intervention.

In the example illustrated in FIG. 6 the service platform 200 comprises a frame 210 that supports a plurality of vertically spaced apart platforms 205 configured as treads that form a plurality of steps. The support platforms or treads 205 may be textured to reduce slippage when the operator stands on the service platform 200. In this way, the spaced apart platforms 205 provide elevated generally planar horizontal support surfaces.

The platform assembly 200 comprises a plurality of feet 215 that extend outward from the frame. The feet provide stable support surfaces when the platform assembly is in contact with the floor 39. The platform assembly 200 also includes one or more roller assemblies 220 that allow the assembly to be rolled through the aisle 40 to easily position the platform assembly within the aisle. In the present instance, the roller assemblies 220 are displaceable between a first position and a second position. In the first position, the roller assemblies 220 engage the track 100 and the feet 215 are elevated from the floor so that the assembly can be readily displaced through the aisle on the rollers. In the second position, the rollers retract so that the feet 215 engage the floor 39 to stabilize the assembly and prevent movement of the platform within the aisle.

In the present instance, the roller assemblies 220 are pivotable. In particular, each roller assembly 220 comprises a pair of rollers or wheels 222 mounted on opposite ends of an axle 225. The platform assembly includes two roller assemblies spaced apart from one another. The axle 225 of each roller assembly is connected to the frame 210 by a pivoting arm so that the axles can be displaced vertically relative to the frame. A biasing element biases the roller assemblies downwardly. When sufficient weight is applied to the service platform, the weight overcomes the bias of the biasing elements so that the pivoting arms pivot upwardly thereby collapsing the rollers up toward the bottom of the frame. When the roller assemblies pivot into the second position, the feet 215 move downwardly until the feet engage the floor 39 to lock the platform in position. It should be noted that the biasing elements provide sufficient biasing force to support the weight of the platform assembly so that the roller assemblies do not pivot into the second position (i.e. the locked position) until weight is applied to the platform assembly.

Since the platform spans across substantially the entire width of the aisle, it is desirable to guide the service platform as it is moved through the aisle. Accordingly, the roller assemblies may be configured to cooperate with the track 100 that guides the automated delivery vehicles. For instance, as shown in FIG. 6 the lower rail 106 of the track 100 may extend into the enclosure 50 and in particular into the storage area 60 of the enclosure. The wheels 222 of the roller assemblies 220 of the platform assembly 200 may be configured to cooperate with the lower track 106. For example, the track 100 may be formed as a c-shaped channel and the wheels may be configured to ride within the channel. The wheels 222 may be positioned so as to engage the lower rail 106 so that the service platform rides on the wheels as the operator pushes the service platform 200 through the aisle. In this way, the same track used to guide the vehicles may be extended into the enclosure to guide the service platform into and through the aisle.

The system 20 may also include a sensor for detecting if the service platform assembly 200 is positioned in the aisle enclosure 50. More specifically, the system may include a sensor to detect whether the service platform assembly is located within the storage area 60 of the aisle enclosure. For example, a sensor may be positioned in the storage area 60. The sensor may detect the presence of the platform assembly. The sensor provides signals to the central controller, which the central controller uses to control operation of the system. For instance, if the sensor detects that the platform assembly 200 is not positioned in the storage area the sensor may provide a signal to the central controller indicative of the platform assembly being out of the storage area. Similarly, the sensor may provide a signal to the central controller when the platform assembly is located in the storage area. When the platform assembly is not in the storage area the sensor does not provide a signal to the central controller. In either instance, the central controller controls the operation of the system in response to signals from the sensor. If the signals are indicative of the platform assembly being outside of the storage area 60, the central controller may stop operation of the system. Stopping the operation of the system operates to prevent damage to the automated vehicles and the service platform that could occur if the automated vehicles travel through the aisle while the service platform is in the aisle instead of the storage are 60.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

What is claimed is:

1. A material handling system, comprising:
a plurality of sort locations for receiving items;
an aisle formed between a plurality of the sort locations wherein the aisle has a floor;
a delivery mechanism operable within the aisle to deliver an item to one of the sort locations; and
a generally horizontal platform elevated above the floor of the aisle, wherein the platform is horizontally displaceable within the aisle.

2. The material handling system of claim 1 comprising a track wherein the delivery mechanism comprises an automated delivery vehicle and the track is configured to guide the vehicle through the aisle, wherein the displaceable platform comprises a roller assembly cooperable with the track to guide the platform within the aisle.

3. The material handling system of claims 1 wherein the platform is configured to support an operator.

4. The material handling system of claim 2 wherein the platform comprises a plurality of feet, wherein the roller assembly is displaceable between a first position and a second position, wherein in the first position the feet are raised so that the feet do not support the weight of the platform and in the second position the feet are lowered to support the weight of the platform.

5. The material handling system of claim 4 comprising a biasing element biasing the roller toward the first position.

6. The material handling system of claim 5 wherein the biasing element biases the roller assembly into the first position against the weight of the platform assembly.

7. The material handling system of claim 1 comprising a sensor for detecting whether the platform is positioned in a storage area outside of the aisle between the storage locations.

8. The material handling system of claim 7 comprising a controller operable to control operation of the delivery mechanism in response to signals received from the sensor.

9. The material handling system of claim 8 wherein the central controller stops operation of the delivery mechanism upon receiving a signal from the sensor indicative of the platform not being located in the storage area.

10. A service platform operable in connection with a material handling system having a plurality of storage locations and an aisle formed between the storage locations and a track for guiding a delivery mechanism in the aisle to deliver items to the storage locations, wherein the service platform comprises:
an elevated platform configured to support an operator so that the operator can operate within the aisle wherein the platform is elevated above a lower surface of the aisle;
a roller assembly connected with the elevated platform, wherein the roller assembly is configured to provide rolling support for the platform to allow the platform to roll within the aisle and wherein the roller assembly is configured to cooperate with the track that guides the delivery mechanism;
a plurality of feet configured to support the elevated platform wherein the feet are configured to prevent the platform from moving in the aisle;
wherein the roller assembly is displaceable relative to the feet between a first position and a second position, wherein in the first position the feet are elevated above the lower surface of the aisle so that the feet do not support the weight of the elevated platform and the roller assembly engages the track to support the weight of the platform; and in the second position the feet support the platform to thereby impede displacement of the platform within the aisle.

11. The service platform of claim 10 comprising a biasing element biasing the roller assembly toward the first position.

12. The service platform of claim 10 comprising a plurality of generally horizontal platforms vertically spaced apart from one another, each forming a support surface for supporting the weight of the operator.

13. The service platform of claim 10 wherein the platform is cooperable with a sensor for detecting whether the platform is positioned in a storage area outside of the aisle between the storage locations.

14. The service platform of claim 13 wherein the service platform is incorporated into the material handling system and the system comprises a controller operable to control operation of the delivery mechanism in response to signals received from the sensor.

15. The service platform of claim 14 wherein the central controller stops operation of the delivery mechanism upon receiving a signal from the sensor indicative of the platform assembly not being located in the storage area.

16. The service platform of claim 10 wherein the roller assembly is configured to cooperate with the track to limit displacement of the platform to displacement along the track while the platform is within the aisle.

17. A material handling system comprising
a plurality of storage locations and an aisle formed between the storage locations;
a track for guiding a delivery mechanism in the aisle to deliver items to the storage locations;
a service platform comprising:
an elevated platform configured to support an operator so that the operator can operate within the aisle wherein the platform is elevated above a lower surface of the aisle;
a roller assembly connected with the elevated platform, wherein the roller assembly is configured to provide rolling support for the platform to allow the platform to roll within the aisle and wherein the roller assembly is configured to cooperate with the track that guides the delivery mechanism; and
a plurality of feet configured to support the elevated platform wherein the feet are configured to prevent the platform from moving in the aisle;
wherein the roller assembly is displaceable relative to the feet between a first position and a second position, wherein in the first position the feet are elevated above the lower surface of the aisle so that the feet do not support the weight of the elevated platform and the roller assembly engages the track to support the weight of the platform; and in the second position the feet support the platform to thereby impede displacement of the platform within the aisle.

18. The material handling system of claim 17 comprising a biasing element biasing the roller assembly toward the first position.

19. The material handling system of claim 17 comprising a plurality of generally horizontal platforms vertically spaced apart from one another, each forming a support surface for supporting the weight of the operator.

20. The material handling system of claim 17 wherein the platform is cooperable with a sensor for detecting whether the platform is positioned in a storage area outside of the aisle between the storage locations.

21. The material handling system of claim 20 wherein the service platform is incorporated into the material handling system and the system comprises a controller operable to control operation of the delivery mechanism in response to signals received from the sensor.

22. The material handling system of claim 21 wherein the central controller stops operation of the delivery mechanism upon receiving a signal from the sensor indicative of the platform assembly not being located in the storage area.

23. The material handling system of claim 17 wherein the roller assembly is configured to cooperate with the track to limit displacement of the platform to displacement along the track while the platform is within the aisle.
